(19) United States
(12) Patent Application Publication
(10) Pub. No.: US 2011/0067011 A1
(43) Pub. Date: Mar. 17, 2011

(54) TRANSFORMATION OF SINGLE-THREADED CODE TO SPECULATIVE PRECOMPUTATION ENABLED CODE

(76) Inventors: Hong Wang, Fremont, CA (US); Perry H. Wang, San Jose, CA (US); Ross David Weldon, Sunnyvale, CA (US); Scott M. Ettinger, Mountain View, CA (US); Hideki Saito, Sunnyvale, CA (US); Milind B. Girkar, Sunnyvale, CA (US); Steve Shih-wei Liao, Palo Alto, CA (US); Mohammad R. Haghighat, San Jose, CA (US); Xinmin Tian, Union City, CA (US); John P. Shen, San Jose, CA (US); Oren Gershon, Haifa (IL)

(21) Appl. No.: 12/949,630

(22) Filed: Nov. 18, 2010

Related U.S. Application Data
(62) Division of application No. 10/334,868, filed on Dec. 31, 2002.

(51) Int. Cl. G06F 9/45

(52) U.S. Cl. 717/140

(57) ABSTRACT

In one embodiment a thread management method identifies in a main program a set of instructions that can be dynamically activated as speculative precomputation threads. A wait/sleep operation is performed on the speculative precomputation threads between thread creation and activation, and progress of non-speculative threads is gauged through monitoring a set of global variables, allowing the speculative precomputation threads to determine its relative progress with respect to non-speculative threads.

### CLAIM OF PRIORITY

The present application claims priority to U.S. patent application Ser. No. 10/334,868 filed Dec. 31, 2002, the entire disclosure of which is hereby incorporated by reference in its entirety.

### FIELD OF THE INVENTION

The present invention relates to computing system software. More particularly, this invention relates to thread management.

### BACKGROUND

Efficient operation of modern computing systems generally requires support of multiple instruction “threads”, with each thread being an instruction stream that provides a distinct flow of control within a program. To improve overall system speed and responsiveness, multiple threads can be simultaneously acted upon by computing systems having multiple processors, each processor supporting a single thread. In more advanced computing systems, multiple threads can be supported by use of processors having a multithreaded processor architecture that are capable of acting on multiple threads simultaneously. Alternatively, a single processor can be multiplexed between threads after a fixed period of time in a technique commonly referred to as time-slice multi-threading. In still another approach known as switch-on-event multithreading, a single processor switches between threads upon occurrence of a trigger event, such as a long latency cache miss.

The concept of multi-threading has been enhanced in a technique called simultaneous multi-threading (“SMT”). Simultaneous multithreading is a processor design that combines hardware multithreading with superscalar processor technology to allow multiple threads to issue instructions each cycle. SMT typically permits all thread contexts to simultaneously compete for and share processor resources. In some implementations, a single physical processor can be made to appear as multiple logical processors to operating systems and user programs, with each logical processor maintaining a complete set of the architecture state, but nearly all other resources of the physical processor, such as caches, execution units, branch predictors, control logic and buses being shared. The threads execute simultaneously and make better use of shared resources than time-slice multithreading or switch-on-event multithreading. Effective utilization of such multithread supporting processors can require procedures for automatically optimizing program behavior and identifying portions of code that are the best candidates for optimization. Optimizing regions of code identified through a set of threading mechanism increases program performance by transforming an original single-threaded application into a de facto multithreaded code. In one known technique a “speculative precomputation” (SP) thread is created to run in parallel with the original code as a main thread. The SP thread will run ahead of the main thread and encounter future cache misses, thus performing effective prefetches for the main thread. This technique is not always reliable however, due to thread synchronization issues.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 schematically illustrates a computing system supporting multithreaded processing;

FIG. 2 schematically illustrates a memory access pattern during speculative precomputation; and

FIG. 3 illustrates program logic for speculative precomputation that includes memory access to global variables for thread synchronization.

### DETAILED DESCRIPTION

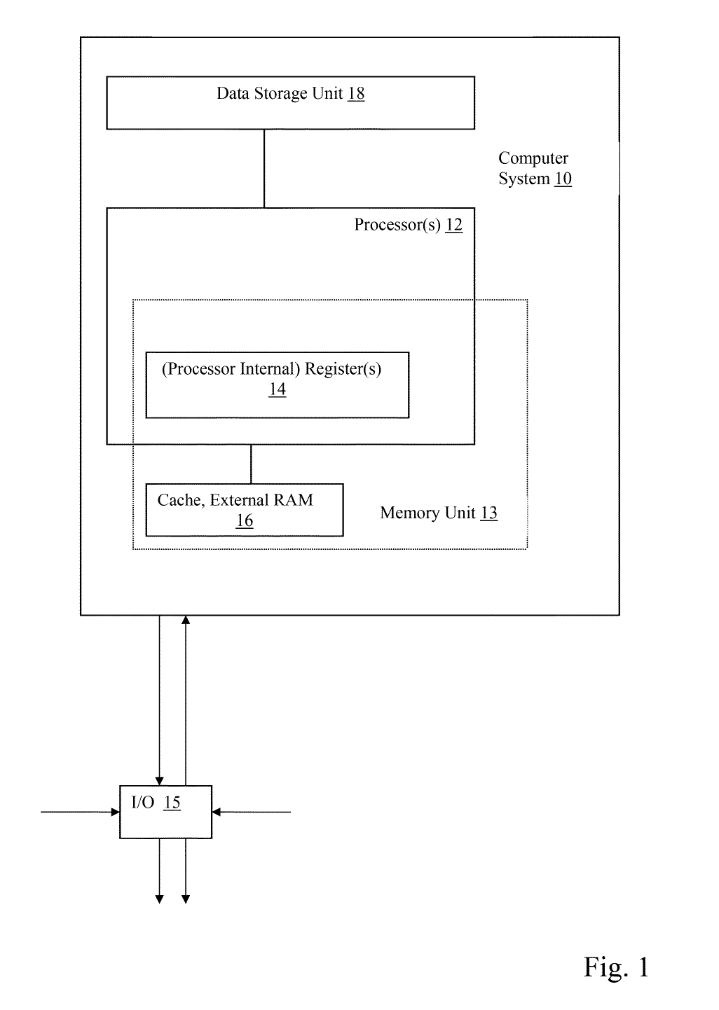

FIG. 1 generally illustrates a computing system 10 having a processor(s) 12 and memory system 13 (which can be external cache memory, external RAM, and/or memory partially internal to the processor) for executing instructions that can be externally provided in software as a computer program product and stored in data storage unit 18. The processor(s) 12 represents one or more processing units for execution of software threads and is capable of supporting multiple threads. Processor 12 may include, but is not limited to, conventional multiplexed processors, multiple processors that share some common memory, chip-multiprocessors “CMP” having multiple instruction set processing units on a single chip, symmetric-multiprocessors “SMP”, or simultaneous multithreaded processors “SMT processors”.

The computer system 10 of the present invention may include one or more I/O (input/output) devices 15, including a display device such as a monitor. The I/O devices may also include an input device such as a keyboard, and a cursor control such as a mouse, trackball, or trackpad. In addition, the I/O devices may also include a network connector such that computer system 10 is part of a local area network (LAN) or a wide area network (WAN).

Examples of a system 10 include, but are not limited or restricted to a computer (e.g., desktop, a laptop, a server, blade server, a workstation, a personal digital assistant, etc.) or any peripherals associated therewith; communication equipment (e.g., telephone handset, pager, etc.); a television set-top box and the like. A “connection” or “link” is broadly defined as a logical or physical communication path such as, for instance, electrical wire, optical fiber, cable, bus trace, or even a wireless channel using infrared, radio frequency (RF), or any other wireless signaling mechanism. In addition, the term “information” is defined as one or more bits of data, address, and/or control. “Code” includes software or firm-ware that, when executed, performs certain functions. Examples of code include an application, operating system, an applet, boot code, or any other series of instructions, or microcode (i.e. code operating at privilege level and below OS).

Alternatively, the logic to perform the methods and systems as discussed above, could be implemented in additional computer and/or machine readable media, such as discrete hardware components as large-scale integrated circuits (LSI's), application-specific integrated circuits (ASIC's), microcode, or firmware such as electrically erasable programmable read-only memory (EEPROM's); or spatially distant computers relaying information through electrical, optical, acoustical and other forms of propagated signals (e.g., radio waves or infrared optical signals).

In one embodiment, a computer program product readable by the data storage unit 18 may include a machine or computer-readable medium having stored thereon instructions which may be used to program (i.e. define operation of) a computer (or other electronic devices) to perform a process according to the present invention. The computer-readable medium of data storage unit 18 may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like, including any methods to upgrade or reprogram or generate or activate or reserve activation of microcode enhancement)

Accordingly, the computer-readable medium includes any type of media/machine-readable medium suitable for storing electronic instructions. Moreover, the present invention may also be downloaded as a computer program product. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

In one embodiment, the methods of the present invention are embodied in machine-executable instructions directed to control operation of the computing system 10, and more specifically, operation of the processor, register, cache memory, and general memory. The instructions can be used to cause a general-purpose or special-purpose processor that is programmed with the instructions to perform the steps of the present invention. Alternatively, the steps of the present invention might be performed by specific hardware components (including microcode) that contain hardwired logic for performing the steps, or by any combination of programmed computer components and custom hardware components.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as pseudocode that generically defines program flow logic, by formula, algorithm, or mathematical expression.

Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

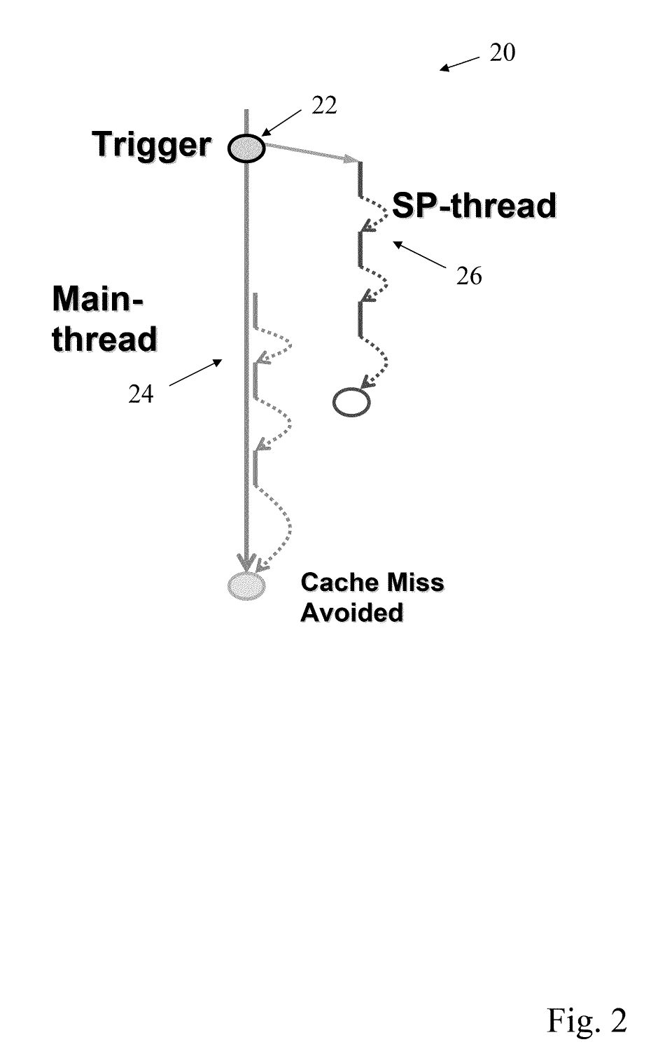

FIG. 2 is a representation 20 thread execution in a computing system that supports a compiler or post-pass optimization layer that can transform single thread applications into speculative precomputation (SP) enhanced multithreading code that employs threads supported explicitly in operating system thread (e.g. WIN32 threading API), user level threads that are transparent to the OS, or hardware threading support via microcode etc. As will be appreciated, support for SP code conversion can be used to target practically any long latency operation which might include indirect branch that is mispredicted. For example, in one embodiment, conversion to SP code typically requires identifying a small set of “delinquent loads”, which are load instructions in a program that incur most cache misses. The set of instructions that lead to address computation for these delinquent loads is identified, and instructions for these delinquent loads are created as a separate SP thread from a main thread that can be dynamically activated. In effect, the SP thread can be created at initialization, yet incur minimal processor overhead during runtime since the SP thread is put to sleep when not used during main thread execution. However, the SP thread, if woken up after initialization by a suitable synchronous or asynchronous trigger and executed to compute the address early and perform the memory access ahead of the main thread, can still result in effective memory prefetches for the delinquent loads. By ensuring that the cache misses happen in the SP thread prior to the access by the main thread (which won't incur the miss) early memory prefetches by an SP thread can help significantly improve performance of the main thread.

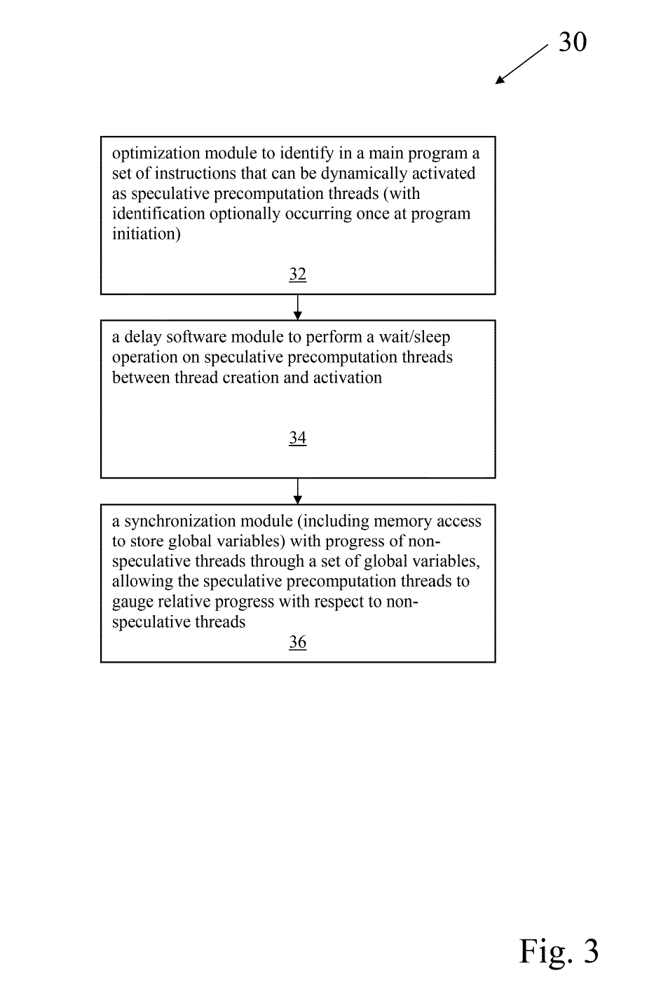

As seen in FIG. 3, the process of SP thread creation and execution 30 begins with an optimization module 32 that is used to identify in a main program a set of instructions that can be dynamically forked as speculative precomputation threads. Identification can dynamically occur once at program initiation or can alternatively occur offline by compiler. In either case (dynamic runtime creation or offline compiler identification) the SP thread is dynamically created as a runtime entity during the program initialization. Such one time SP thread creation is useful because thread creation is typically a computationally expensive process. Creating a new SP thread whenever one is needed would negate the speedup gained by using speculative precomputation. Creating SP threads only once at the beginning of all applications amortizes overall cost of thread creation.

A delay software module 34 is used to perform a wait/sleep operation on speculative precomputation threads between thread creation and activation. SP threads run only as often as their corresponding sections in their respective non-speculative threads. In most applications there is some discrete time between SP thread creation and SP thread activation, as well as time between successive SP thread activations. During these times, the SP thread perform a wait/sleep operation to allows the SP thread to yield to other processes that the system may wish to run on that logical processor.

A synchronization module 36 (which includes memory access functionality to store global variables) tracks progress of non-speculative threads through a set of global variables, allowing the speculative precomputation (SP) threads to gauge relative progress with respect to non-speculative threads. Given that both SP and non-SP threads may be reading and writing to a set of shared variables, it has been shown to be helpful to bound all accesses to this set of global variables with a fast, synchronization object. The synchronization object can be directly from OS thread API such as the event object manipulated by setEvent( ) and waitForSingleObject( ) in Win32 thread API or equivalent API in pthread. Alternatively, such synchronization object can be implemented via suitable hardware thread wait monitor that allows a thread to define a cache line aligned memory address as monitor, and a load access to this monitor object can suspend the execution of a said thread—making it semantically equivalent to waitForSingleObject( ) and a store access to the monitor can wake up the suspended thread—thus equivalent to setEvent( ). It can be noted however, that while monitor write and mwait are much more efficient than an OS level thread API, implementation of the described embodiment is applicable to any hardware, software, or mixed hardware and software mechanism that supports wait and wakeup.

In addition to use of global variables and provision of a wait state, code transformation for SP optimized operation can further include provisions to limit the frequency of communication between the SP thread and the non-speculative main thread. Defining “stride” as a variable equal to the number of iterations of loops that a SP thread is set to run ahead relative to a non-speculative main thread, the threads can be set to only access the set of shared global variables after stride operations. This minimizes communication, with thread run-ahead and fall-behind also being limited to units of size stride. In certain embodiments where the SP thread consistently runs just ahead of the non-speculative thread, and any synchronizing communication is unnecessary overhead, stride dependent communication limitations are not used. As will be appreciated, stride choice often impacts performance of the application. If the stride is set too low (with run-ahead distance is being too short, more frequent inter-thread communication needed, and frequent non-timely memory access by the SP thread), communication overhead begins to negate the benefit of the SP thread. On the other hand, if it is set too high the SP thread may run too far ahead and some previously prefetched data can be overridden before use by the main thread, there may be insufficient thread communication, and erroneous or unnecessary (i.e. untimely) prefetches may result.

In the majority of applications, the SP thread had been observed to fall behind and/or run significantly ahead of the non-speculative thread. Fall behind and/or run ahead frequency can be minimized via good communication between threads by dynamically increasing or decreasing execution of the speculative thread. If the SP thread finds it is behind the non-speculative thread, it should effectively increase its execution by attempt to jump ahead to the last communicated location. On the other hand, if the SP thread finds it has run ahead of the non-speculative thread, it can employ one of two techniques to decrease execution: wait and jump-back. With the wait technique, the SP threads simply yield and wait to be signaled by the non-speculative thread. Alternatively, a jump-back technique can be used in which SP thread execution requires jump back to the last known location of the non-speculative thread, and begin prefetching again.

A SP thread may also fall behind its non-speculative thread. If this occurs, and the non-speculative thread has completed the section of code the SP is prefetching for, the application may incur additional, unnecessary cache misses while the SP thread continues to run. In one embodiment, the SP thread includes a throttling mechanism at the end of each stride of run-ahead operation to check the relative progress of the main thread (via global variable for trip count) and then determine whether it is running too far ahead or running behind the main thread. The run-ahead strategy can be accordingly adjusted to either continue to do another round of prefetch (if not running too far ahead), or put itself to sleep and wait for the next wakeup from the main thread (if running too far ahead or behind), or sync up with the main thread's progress (by syncing prefetch's starting pointer via the global variable) and continue to run the prefetch.

To enhance efficiency, the SP thread should, at its core, contain only those instructions necessary for determining the desired long latency operation (e.g. a memory load) sequence required by the non-speculative main thread. Thus it is desirable to minimize the number of function calls from the SP thread via function inlining. Inlining is useful, for example, in applications such as a minimal spanning tree (MST) that repeatedly loops over a list of hash tables and performs a lookup on each of those tables (which requires traversing another list).

Recursive functions can also be the source of delinquent loads that would be minimized by addition of SP thread functionality. Since recursive functions can be difficult to directly transform into SP threads for 2 reasons: the stack overhead of the recursive call can be prohibitively expensive, and jump-ahead code if difficult (if not impossible) to implement, it is sometimes useful to transform the recursive function into a loop-based function for the SP thread.

To better illustrate one embodiment of a method and system for conversion of single threaded code into optimized code having speculative precomputation, consider the following single threaded pseudocode:

| | |
|---|---|
| 1 | main( ) |
| | { |
| 2 | n = NodeArray[0] |
| 3 | while(n and remaining) |
| | { |
| 4 | work( ) |
| 5 | n->i = n->next->j + n->next->k + n->next->l |
| 6 | n = n->next |
| 7 | remaining−− |
| | } |
| | } |

In one embodiment, when executed, line 4 requires 49.47% of total execution time, while line 5: requires about 49.46% of total execution time. Line 5 also has 99.95% of total L2 misses, making it an ideal candidate for optimization using speculative precomputation threads.

The following illustrates an example of pseudocode suitable for running the foregoing pseudocode with increased efficiency. A “Main” thread is generated such that:

| | |
|---|---|
| 1 | main( ) |
| { | |
| 2 | CreateThread(T) |
| 3 | WaitForEvent( ) |
| 4 | n = NodeArray[0] |
| 5 | while(n and remaining) |
| | { |
| 6 | work( ) |
| 7 | n->i = n->next->j + n->next->k + n->next->l |
| 8 | n = n->next |
| 9 | remaining−− |
| 10 | Every stride times |
| 11 | global_n = n |
| 12 | global_r = remaining |
| 13 | SetEvent( ) |
| | } |
| } | |

Line 7 corresponds to Line 5 of the single threaded code, and Line 13 SetEvent is a synchronous trigger (where an API call is statically placed at specific location in the code, as contrasted to asynchronous trigger where the code location when triggered is not initially known) to launch the following speculative precomputation (SP) thread (hereafter alternatively known as a “scout”, “worker” or “helper” thread):

| | |
|---|---|
| 1 | T( ) |
| | { |
| 2 | Do Stride times |
| 3 | n->i = n->next->j + n->next->k + n->next->l |
| 4 | n = n->next |
| 5 | remaining−− |
| 6 | SetEvent( ) |
| 7 | while(remaining) |
| | { |
| 8 | Do Stride times |
| 9 | n->i = n->next->j + n->next->k + n->next->l |
| 10 | n = n->next |
| 11 | remaining−− |
| 12 | WaitForEvent( ) |
| 13 | if(remaining < global_r) |
| 14 | remaining = global_r |
| 15 | n = global_n |
| | } |
| | } |

Line 9 is responsible for most effective prefetch due to run-ahead, while line 15 detects run-behind and adjusts by jumping ahead.

Overall, execution time of Line 7 in the main thread (corresponding to line 5 in the single threaded case) is 19% vs 49.46% in single-thread code. The L2 cache miss is a negligible 0.61% vs 99.95% in single-thread code. Line 9 of speculative precomputation thread (corresponding to Line 7 of the main thread) has an execution time of 26.21% and an L2 miss of 97.61%, indicating that it is successful in shouldering most L2 cache misses.

To achieve such performance results, the speculative precomputation (SP) worker thread T( ) essentially performs the task of pointer-chasing in the main loop, and it does not perform the work( )operations. In essence, the worker probes or scouts the load sequence to be used by the main loop and effectively prefetches the required data.

There is only one worker thread created at the beginning of the program, and it lives until there are no longer any loop iterations to be performed. In certain embodiments, processor architectures that supports two or more physical hardware thread contexts and have a relative heavy cost of creating a new thread can map the worker thread to a second hardware thread. In effect, there is no additional thread spawning, and the cost of thread spawning is amortized across the program to become virtually unnoticeable.

Once the SP thread is created, the main thread waits for the SP thread to indicate that it has completed its pre-loop work. A more elaborately tuned SP thread can probe more than one iterations of the initial pointer chasing for this pre-loop work.

Essentially, the SP worker thread performs all of its precomputation in units of size stride as previously defined. This both minimizes communication and limits thread run-ahead, while effectively setting limits to how many iterations a precomputation thread can run ahead of the main thread. If run-ahead is too far, the precomputation induced prefetches could not only displace temporally important data to be used by the main thread but also potentially displace earlier prefetched data that have not been used by the main thread. On the other hand, if the run-ahead distance is too short, then the prefetch could be too late to be useful.

In the foregoing pseudocode example of a speculative precomputation worker thread, the worker thread's pre-loop work consists of performing stride loops, i.e. prefetches, shown between Line 2-5. Every stride loops in the main thread, a global copy of the current pointer and the number of loops remaining are updated, shown between Line 10-12. Additionally, the main thread signals the worker thread that it may continue prefetching, shown at Line 13, if the worker is stalled because it ran too far ahead. After prefetching in chunks of stride length, shown at Line 8-11, the worker thread waits for a signal from the main thread to continue. Again, this prevents the worker from running too far ahead of the main thread. More importantly, before looping over another stride iterations, the worker thread examines whether its remaining iterations are greater than the global version. If so, the worker thread has fallen behind, and must “jump ahead” by updating its state variables to those stored in the global variables (Lines 13-15).

The following respective “Single Threaded Code” and modified “Speculative Computation Multithreaded Version” illustrates conversion of single threaded code using algorithms corresponding to the foregoing pseudocode:

### Single Threaded Code

#include <stdio.h>
#include <stdlib.h>
typedef struct node node;

| | | | |
|---|---|---|---|
| node* | pNodes | = NULL; | //a pointer to the array of all nodes |

struct node

| | | | |
|---|---|---|---|
| { | | | |
| | node* | next; | //pointer to the next node |
| | int | index; | //location of this node in the array |
| | int | in; | //in-degree |
| | int | out; | //out-degree |
| | int | i; | |
| | int | j; | |
| | int | k; | |
| | int | l; | |
| | int | m; | |

};
//function declarations
void InitNodes(int num_nodes);
int main(int argc, char *argv[ ])
{

| int num nodes = 500; | //the total number of nodes |
|---|---|
| node* n; | |
| register int num_work = 200; | |
| register int remaining = 1; | //the number of iterations we are |

going to perform

register int i = 0;
if(argc > 1)

num_nodes = atoi(argv[1]);

if(argc > 2)

num_work = atoi(argv[2]);

if(argc > 3)

remaining = atoi(argv[3]);

remaining = num_nodes * remaining;
InitNodes(num_nodes);
n = &(pNodes[0]);
while (n && remaining)
{

for(i = 0; i < num_work; i++)
{

_{——}asm { pause };

}
n−>i = n−>next−>j + n−>next−>k + n−>next−>l +
n−>next−>m;
n = n−>next;
remaining--;

}
free(pNodes);

}
void InitNodes(int num_nodes)
{

| int i = 0; | | |
|---|---|---|
| int r = 0; | | |
| node* pTemp = NULL; | | |
| pNodes = malloc(num_nodes * sizeof(node)); | | |
| //seed the “random” number generator | | |
| srand(123456); | | |
| for (i=0; i < num_nodes; i++) | | |
| { | | |
| | pNodes[i].index = i; | |
| | pNodes[i].in = 0; | |
| | pNodes[i].out = 0; | |
| | pNodes[i].i | = 0; |
| | pNodes[i].j | = 1; |
| | pNodes[i].k | = 1; |
| | pNodes[i].1 | = 1; |
| | pNodes[i].m | = 1; |
| } | | |

pNodes[num_nodes−1].next = &(pNodes[0]);
pNodes[num_nodes−1].out = 1;
pNodes[0].in = 1;
for (i=0; i < num_nodes−1; i++)
{

r = i;
while (r == i || pNodes[r].in == 1)

r = rand( ) % num_nodes;

pNodes[i].out = 1;
pNodes[r].in = 1;
pNodes[i].next = &(pNodes[r]);

| | |
|---|---|
| | } |
| } | |

### Speculative Computation Multithreaded Version

#include <stdio.h>
#include <stdlib.h>
#include “..\..\IML\libiml\iml.h”
typedef struct node node;
typedef struct param param;

| node* | pNodes | = NULL; | //a pointer to the array of all nodes |
|---|---|---|---|
| HANDLE | event; | | //used for cross-thread event signaling |
| node* global_n = NULL; | | | //shared vars for T0/T1 communication |
| int global_r = 0; | | | |
| struct node | | | |
| { | | | |
| | node* | next; | //pointer to the next node |
| | int | index; | //location of this node in the array |
| | int | in; | //in-degree |
| | int | out; | //out-degree |
| | int | i; | |
| | int | j; | |
| | int | k; | |
| | int | l; | |
| | int | m; | |
| }; | | | |
| struct param | | | //the params we will pass to the worker thread |
| { | | | |
| | node* n; | | //pointer to the first node to loop over |
| | int r; | | //the total number of loop iterations |
| | int s; | | //the “look ahead” stride |
| }; | | | |

//function declarations
void InitNodes(int num_nodes);
void Task(param* p);
int main(int argc, char *argv[ ])

| { | | | | | |
|---|---|---|---|---|---|
| | int remaining | | = 1; | | //the total number of loop iterations |
| | int num_nodes | | = 500; | | //the total number of nodes |
| | int stride | | | = 4; | //the number of loads the worker thread can perform |
| | | | | | //before it waits for the main thread |
| | node* | n; | | | |
| | register int num_work | | | = 200; | |
| | register int i | | | | = 0; |
| | register int j | | | | = 0; |
| | param P; | | | | |
| | if(argc > 1) | | | | |
| | | num_nodes = atoi(argv[1]); | | | |
| | if(argc > 2) | | | | |
| | | num_work = atoi(argv[2]); | | | |
| | if(argc > 3) | | | | |
| | | remaining = atoi(argv[3]); | | | |
| | if(argc > 4) | | | | |
| | | stride = atoi(argv[4]); | | | |
| | remaining = num_nodes * remaining; | | | | |
| | InitNodes(num_nodes); | | | | |
| | event = CreateEvent(NULL,FALSE,FALSE,NULL); | | | | |
| | n = &(pNodes[0]); | | | | |
| | P.n = n; | | | | |
| | P.r = remaining; | | | | |
| | P.s = stride; | | | | |
| | CreateThread(NULL,0,(LPTHREAD_START_ROUTINE)Task,&P,0,NULL); | | | | |
| | //wait for the worker thread to do pre-loop work | | | | |
| | WaitForSingleObject(event,INFINITE); | | | | |
| | while (n && remaining) | | | | |
| | { | | | | |
| | | for(i = 0; i < num_work; i++) | | | |
| | | { | | | |
| | | | _{——}asm { pause }; | | |
| | | } | | | |
| | | n−>i = n−>next−>j + n−>next−>k + n−>next−>l + n−>next−>m; | | | |
| | | n = n−>next; | | | |
| | | remaining--; | | | |
| | | if(++j >= stride) | | | |
| | | { | | | |
| | | | j = 0; | | |
| | | | global_n = n; | | |
| | | | global_r = remaining; | | |
| | | | SetEvent(event); | | |
| | | } | | | |
| | } | | | | |
| | free(pNodes); | | | | |
| } | | | | | |
| void Task(param* p) | | | | | |
| { | | | | | |
| | register node* n | | | | = p−>n; |
| | register int stride | | | | = p−>s; |
| | register int local_remaining | | | | = p−>r; |
| | register int i | | | | = 0; |
| | //pre-loop work | | | | |
| | for (i=0; i < stride; i++) | | | | |
| | { | | | | |
| | | n−>i = n−>next−>j + n−>next−>k + n−>next−>l + n−>next−>m; | | | |
| | | n = n−>next; | | | |
| | | local_remaining--; | | | |
| | } | | | | |
| | //allow the main loop in the main thread to begin | | | | |
| | SetEvent(event); | | | | |
| | //main loop work | | | | |
| | while (local_remaining) | | | | |
| | { | | | | |
| | | | i = 0; | | |
| | | | while (i < stride) | | |
| | | | { | | |
| | | | | n−>i = n−>next−>j + n−>next−>k + n−>next−>l + n−>next−>m; | |
| | | | | n = n−>next; | |
| | | | | local_remaining--; | |
| | | | | i++; | |
| | | | } | | |
| | | | WaitForSingleObject(event, INFINITE); | | |
| | | | if(local_remaining > global_r) | | |
| | | | { | | |
| | | | | local_remaining = global_r; | |
| | | | | n = global_n; | |
| | | | } | | |
| | } | | | | |
| } | | | | | |
| void InitNodes(int num_nodes) | | | | | |
| { | | | | | |
| | int i = 0; | | | | |
| | int r = 0; | | | | |
| | node* pTemp = NULL; | | | | |
| | pNodes = malloc(num_nodes * sizeof(node)); | | | | |
| | //seed the “random” number generator | | | | |
| | srand(123456); | | | | |
| | for (i=0; i < num_nodes; i++) | | | | |
| | { | | | | |
| | | pNodes[i].index = i; | | | |
| | | pNodes[i].in | | = 0; | |
| | | pNodes[i].out | | = 0; | |
| | | pNodes[i].i | | = 0; | |
| | | pNodes[i].j | | = 1; | |
| | | pNodes[i].k | | = 1; | |
| | | pNodes[i].l | | = 1; | |
| | | pNodes[i].m | | = 1; | |
| | } | | | | |
| | pNodes[num_nodes−1].next = &(pNodes[0]); | | | | |
| | pNodes[num_nodes−1].out = 1; | | | | |
| | pNodes[0].in = 1; | | | | |
| | for(i=0; i < num_nodes−1; i++) | | | | |
| | { | | | | |
| | | r = i; | | | |
| | | while (r == i \|\| pNodes[r].in == 1) | | | |
| | | | r = rand( ) % num_nodes; | | |
| | | pNodes[i].out = 1; | | | |
| | | pNodes[r].in = 1; | | | |
| | | pNodes[i].next = &(pNodes[r]); | | | |
| | } | | | | |
| } | | | | | |

In another specific embodiment intended to illustrate conversion of a code snippet into a form suitable for efficiently operating with speculative precomputation, the structure of the speculative precomputation thread is as follows:

while (1) {

Wait for signal from main thread
for/while loop

loop control

intermittent prefetches to delinquent loads

adjustment for out-of-synch thread

}

The code segment to be altered to support threads of the foregoing structure is known as the MCF program:

while( node != root ) {

while( node ) {

if( node−>orientation == UP )

node−>potential = node−>basic_arc−>cost +

node−>pred−>potential;

else /* == DOWN */
{

node−>potential = node−>pred−>potential − node−

>basic_arc−>cost;

checksum++;

}
tmp = node;
node = node−>child;

}
node = tmp;
while( node−>pred ) {

tmp = node−>sibling;
if( tmp ) {

node = tmp;
break;

}
else

node = node−>pred;

}

}

The SP thread is setup so that:

### SP Thread:

g_root = root;
SetEvent(g_event_start_a);
while( node != root ) {

while( node ) {

if( node−>orientation == UP )

node−>potential = node−>basic_arc−>cost

+ node−>pred−>potential;

else /* == DOWN */
{

node−>potential = node−>pred−>potential

− node−>basic_arc−>cost;

checksum++;

}
tmp = node;
node = node−>child;

}
node = tmp;
while( node−>pred ) {

tmp = node−>sibling;
if( tmp ) {

node = tmp;
break;

}
else

node = node−>pred;

}

}

### SP Thread:

while (1) {

WaitForSingleObject(g_event_start_a, INFINITE);
sp_root = g_root;
sp_tmp = sp_node = sp_root−>child;

/* INSERT SP CODE HERE */

}

Loop control is duplicated as follows:

### SP Thread:

while (1) {

WaitForSingleObject(g_event_start_a, INFINITE);
sp_root = g_root;
sp_tmp = sp_node = sp_root−>child;
while( sp_node != sp_root ) {

while(sp_node ) {

sp_tmp = sp_node;
sp_node = sp_node−>child;

}
sp_node = sp_tmp;
while( sp_node−>pred ) {

sp_tmp = sp_node−>sibling;
if( sp_tmp ) {

sp_node = sp_tmp;
break;

}
else

sp_node = sp_node−>pred;

}

}

}

While synchronization issues are handled by adjusting for fall-behind or run-ahead thread through insertion of an internal loop counter and stride counter:

### Main Thread:

g_root = root;
SetEvent(g_event_start_a);
while( node != root ) {

. . . . . .
. . . . . .
m_stride_count++;
m_loop_count++;

}

### SP Thread:

while (1) {

WaitForSingleObject(g_event_start_a, INFINITE);
sp_root = g_root;
sp_tmp = sp_node = sp root−>child;
while( sp_node != sp_root ) {

. . . . . .
. . . . . .
sp_stride_count++;
sp_loop_count++;

}

}

Sychronization with the main thread is as follows:

### Main Thread:

m_stride_count++;
m_loop_count++;
if (m_stride_count >= STRIDE) {

g_node = node;
g_loop_count = m_loop_count;
SetEvent(g_event_continue);
m_stride_count = 0;

}

### SP Thread:

sp_stride_count++;
sp_loop_count++;
If (sp_stride_count >= STRIDE) {

WaitForSingleObject(g_event_continue,INFINITE);
if (g_loop_count > sp_loop_count)
{ // fallen behind, jump start

sp_loop_count = g_loop_count;
sp_node = g_node;

}
else if ((g_loop_count+STRIDE) < sp_loop_count)
{ // ahead, pull back and start again

sp_loop_count = g_loop_count;
sp_node = g_node;

}
sp_stride_count = 0;

}

Atomic update of MCF code with an internal counter is:

### Main Thread:

m_stride_count++;
m _loop_count++;
if (m_stride_count >= STRIDE) {

EnterCriticalSection( &cs );
g_node = node;
g_loop_count = m_loop_count;
LeaveCriticalSection( &cs );

m_stride_count = 0;
}

### SP Thread:

sp_stride_count++;
sp_loop_count++;
If (sp_stride_count >= STRIDE) {

if (g_loop_count > sp_loop_count)
{ // fallen behind, jump start

EnterCriticalSection( &cs );
sp_loop_count = g_loop_count;
sp_node = g_node;
LeaveCriticalSection( &cs );

}
else if ((g_loop_count+STRIDE) < sp_loop_count)
{ // ahead, pull back and start again

EnterCriticalSection( &cs );
sp_loop_count = g_loop_count;
sp_node = g_node;
LeaveCriticalSection( &cs );

}
sp_stride_count = 0;

}

Other MCF code enhancements include other enhancements SP thread termination by run-ahead main thread and intermittent prefetches of delinquent loads in loop body:

### Main Thread:

while( node != root ) {

. . . . .

}
EnterCriticalSection( &cs );
g_node = root;
g_loop_count = m_loop_count;
LeaveCriticalSection( &cs );

### SP Thread:

while( sp_node != sp_root ) {

while(sp_node ) {

if ((sp_loop_count % 100) == 0 ||

(ahead_count--) > 0)

temp = node−>basic_arc−>cost

+ node−>pred−>potential;

sp_tmp = sp_node;
sp_node = sp_node−>child;

}
. . . . . . .
If (sp_stride_count >= STRIDE) {

. . . . . . .
else if ((g_loop_count+STRIDE) < sp_loop_count)
{ // don't pull back

ahead_count = 15;

}
sp_stride_count = 0;

}

}

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Accordingly, it is the following claims including any amendments thereto that define the scope of the invention.

1. A method for synchronization between a main thread and a scout thread, comprising:
identifying in a main software program one or more target instructions for which a scout thread is to be generated; generating, by a compiler prior to runtime, software code for the scout thread that includes an instruction to cause a prefetch for at least one of the target instructions;
wherein generating software code for the scout thread further includes generating code to check the progress of at least a portion of the main software program and to discontinue execution of the scout thread responsive to determining that the code being executed by the scout thread meets a first condition;
whereby at runtime the scout thread code is executed in advance of the portion of the main software program in order to prefetch data items for the portion of the main software program.

2. The method of claim 1, wherein said first condition further comprises that the code being executed by the scout thread is not prefetching useful information for the portion of the main software program.

3. The method of claim 1, wherein generating software code for the scout thread further includes generating code to discontinue execution of the scout responsive to determining that the code being executed by the scout thread is running behind the portion of the main software program.

4. An article comprising a computer-readable storage medium having stored thereon instructions that when executed by a machine result in:
identifying in a main software program one or more target instructions for which a scout thread is to be generated;
generating, by a compiler prior to runtime, software code for the scout thread that includes an instruction to cause a prefetch for at least one of the target instructions;
wherein generating software code for the scout thread further includes generating code to check the progress of at least a portion of the main software program and to discontinue execution of the scout thread responsive to determining that the code being executed by the scout thread meets a first condition;
whereby at runtime the scout thread code is executed in advance of the portion of the main software program in order to prefetch data items for the portion of the main software program.

5. The article comprising a storage medium having stored thereon instructions of claim 4, wherein said first condition further comprises that the code being executed by the scout thread is not prefetching useful information for the portion of the main software program.

6. The article comprising a storage medium having stored thereon instructions of claim 4, wherein the instructions for generating code for the scout thread further include instructions for generating code to discontinue execution of the scout responsive to determining that the code being executed by the scout thread is running behind the portion of the main software program.
